(19) United States
(12) Patent Application Publication
(10) Pub. No.: US 2006/0007070 A1
(43) Pub. Date: Jan. 12, 2006

(54) Driving circuit and driving method for electroluminescent display

(76) Inventor: Li-Wei Shih, Minhsiung Township (TW)

Correspondence Address: David I. Roche;BAKER & McKENZIE, 130 E. Randolph Drive, Chicago, IL, 60601, US

(21) Appl. No.: 10/858,816

(22) Filed: Jun. 2, 2004

(51) Int. Cl. G09G 3/30

(52) U.S. Cl. 345/76

(57) ABSTRACT

A pixel driving circuit is implemented to drive an electroluminescent display system. In the driving circuit, a constant voltage potential is applied to the drain of a driving transistor while an electric current determined according to a data signal is delivered through the source and drain of the driving transistor to the light-emitting device. A stable electric current thereby flows through the light-emitting device.

### BACKGROUND OF THE INVENTION

1. Field of the Invention

This invention generally relates to the field of electroluminescent displays, and more particularly to a driving circuit implemented to drive the operation of a light-emitting device of the electroluminescent display.

2. Description of the Related Art

Electroluminescent displays are subjected to intense researches and developments in the field of emissive displays. Compared to other types of emissive displays such as the plasma displays, the electroluminescent display provides many advantages such as a lower power consumption, a reduced size, and a high image brightness. An electroluminescent display system conventionally includes a mesh of scan and data lines that define an array of pixels in each of which is coupled one light-emitting device. The light-emitting device particularly can be an organic light-emitting device (OLED), and is usually driven by a driving circuit associated to each pixel.

FIG. 1A is a schematic view of a coneventional driving circuit implemented in one pixel. The pixel driving circuit includes two transistors 102, 104, a storage capacitor 108, and an organic light-emitting device 106. The transistors can be any type of transistor, such as thin film transistor or the like. The transistors 102, 104 can be NMOS transistors in the following description. The transistor 102 has a gate connected to a scan line SCAN, and a source connected to a data line DATA. The transistor 104 has a gate connected to the drain of the transistor 102, a source connected to a power voltage V_{dd}, and a drain connected to an electrode terminal of the OLED 106. The other electrode terminal of the OLED 106 is connected to a common voltage Vₛₛ. The storage capacitor 108 is coupled between the drain and the gate of the transistor 104.

In operation, a high voltage level of the scan line SCAN turns on the transistor 102, and charge the storage capacitor 108 with the data line voltage DATA. As a result, the charged storage capacitor 108 turns on the transistor 104 that accordingly experiences the flow of an electric current towards the OLED 106. The transistor 104 conventionally works in a saturation range, and the electric current I delivered to the OLED 106 can be expressed as follows:
I=k(V_{A}−V_{B}−Vₜₕ)² (1)
wherein k is a constant coefficient, V_{A} is the gate voltage of the transistor 104 at node A, V_{B} is the source voltage of the transistor 104 at node B, and Vₜₕ is the threshold voltage of the transistor 104.

As illustrated in FIG. 1B, it can be observed that the voltage V_{B} timely increases in operating the OLED 106. One reason of this deviation includes an alteration of the transistor characteristics. As indicated by the expression (1), the increase of V_{B} results in a reduction of the electric current flowing across the OLED 106 and consequently affects the brightness of the light emitted from the OLED 106. As a result, the service life of the OLED is adversely reduced.

Therefore, there is a need in the art for a pixel driving circuit that can improve the service life of the OLED.

### SUMMARY OF THE INVENTION

The application describes a pixel driving circuit and a pixel driving method which can be implemented in an electroluminescent display system without the prior art problems. The electroluminescent display system includes a plurality of light-emitting devices respectively coupled with scan and data lines.

In one embodiment, the pixel driving circuit comprises a pixel driving circuit coupled with a scan line, a data line and one or more light-emitting device, and a voltage clamp circuit coupled between the pixel driving circuit and the light-emitting device. The pixel driving circuit when turned on in response to a scan signal issued on the scan line is configured to deliver to the light-emitting device an electric current set according to a data signal delivered through the data line.

The voltage clamp circuit is operable to apply a voltage potential at a connection node between the pixel driving circuit and the light-emitting device when an electric current is delivered to the light-emitting device. In one embodiment, the voltage potential applied at the connection node between the pixel driving circuit and the light-emitting device is constant.

In one embodiment, the pixel driving circuit includes a driving transistor having its source and drain coupled between the light-emitting device and a power voltage potential. The driving transistor is operated in a saturation range to deliver an electric current to the light-emitting device.

In another embodiment, a method of driving an electroluminescent display comprises operating the driving transistor in a saturated range to deliver an electric current to the light-emitting device of the selected pixel, wherein the electric current varies according to the level of the data signal, and applying a constant voltage bias between the gate and the drain of the driving transistor while the driving transistor is operated in the saturated range.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic diagram of a conventional pixel driving circuit implemented in an electroluminescent display according to the prior art;

FIG. 1B is a graph depicting the characteristic bias of the driving circuit implemented in the prior art;

FIG. 2A is a block diagram of a pixel circuit implemented in an electroluminescent display according to an embodiment of the invention;

FIG. 2B is a circuit diagram illustrating a circuit implementation of the pixel circuit in an electroluminescent display according to an embodiment of the invention;

FIG. 3A is a time chart describing the operation of a pixel driving circuit implemented in an electroluminescent display according to an embodiment of the invention; and

FIG. 3B is a flowchart of a method of driving an electroluminescent display according to an embodiment of the invention.

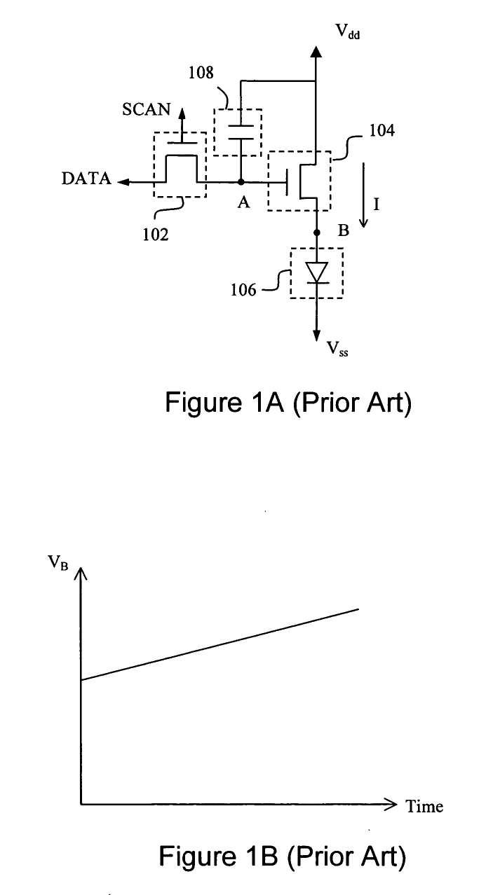

### DETAILED DESCRIPTION OF THE EMBODIMENT(S)

The application describes a pixel driving circuit and a driving method implemented in an electroluminescent display. In the following description, numerous details are set forth in order to provide a thorough understanding of the present invention. It will be appreciated by one skilled in the art that many variations of these specific details are possible to achieve the inventive features as described herein.

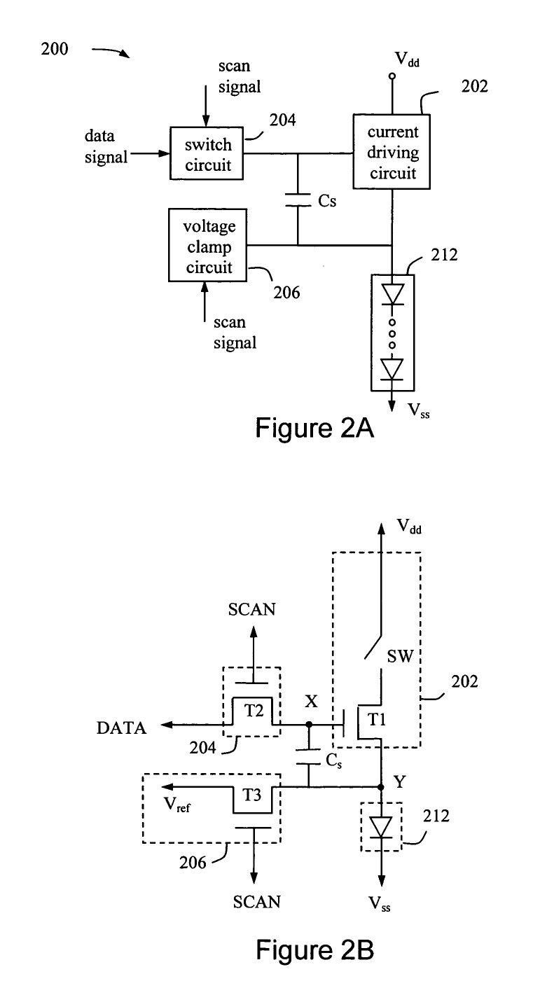

FIG. 2A is a block diagram of a pixel circuit implemented in an electroluminescent display according to an embodiment of the invention. The electroluminescent display can be exemplary an active matrix organic light-emitting display system. The pixel 200 includes a current driving circuit 202, a switch circuit 204, a voltage clamp circuit 206, a storage capacitor Cₛ, and one or more light emitting device 212. The light-emitting device can be an organic light-emitting device. The current driving circuit 202 couples the storage capacitor Cₛ to one or more light-emitting device 212. The switch circuit 204 operates to charge the storage capacitor Cₛ with a data signal DATA upon receiving a scan signal SCAN indicating the selection of the light-emitting device 212. Both current driving circuit 202 and switch circuit 204 are thereby configured to deliver an electric current to the light-emitting device 212 according to the level of the data signal DATA.

The voltage clamp circuit 206 connects to the node Y that links the connecting the current driving circuit 202 to the light-emitting device 212. The voltage clamp circuit 206 is operable to apply a voltage potential to the node Y when an electric current is delivered, according to the data signal stored in the storage capacitor Cₛ, through the current driving circuit 202 to the light-emitting device 212. The voltage control applied to the node Y can prevent undesirable variations of the electric current delivered to the light-emitting device 212.

FIG. 2B is a circuit diagram illustrating a circuit implementation of the pixel circuit according to an embodiment of the invention. The light-emitting device 212 is connected between a voltage potential Vₛₛ and a voltage node Y, output of the current driving circuit 202. The current driving circuit 202 includes a transistor T1 having its source connected via a switch SW to a power voltage V_{dd}, its drain connected via the node Y to the light-emitting device 212, and its gate coupled with the storage capacitor Cₛ. The switch circuit 204 includes a transistor T2 having its gate connected to the scan line SCAN, and its source and drain coupled between the data signal DATA and the storage capacitor Cₛ. The voltage clamp circuit 206 includes a transistor T3 having its gate connected to the scan line SCAN, and its source and drain coupled between a reference voltage V_{ref} and the node Y.

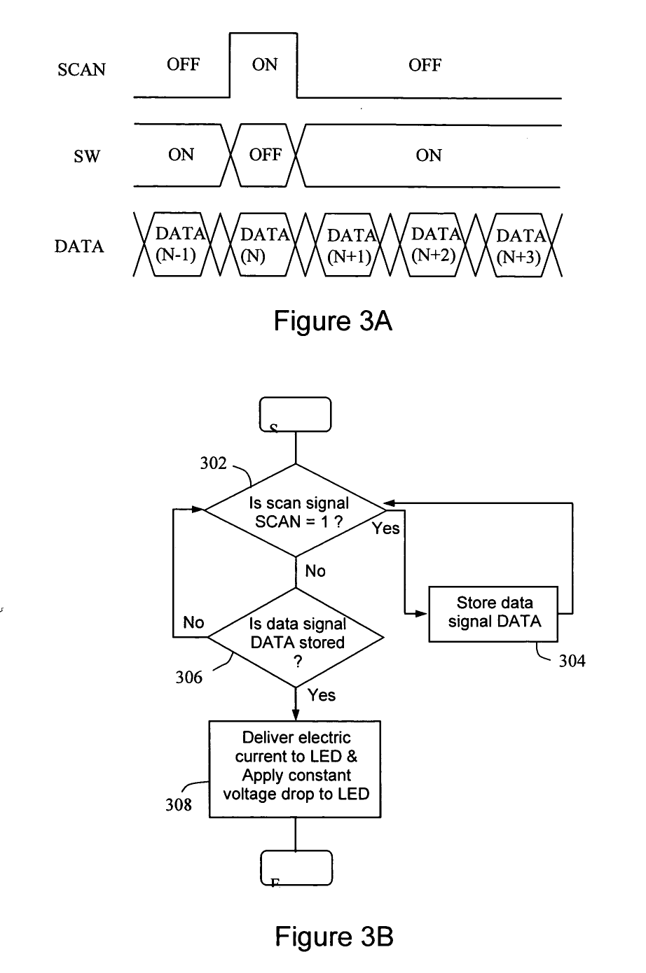

FIG. 3A is a time chart depicting the operation of the pixel driving circuit of FIG. 2B according to an embodiment of the invention. A high voltage level of the scan signal SCAN turns both transistors T2, T3 to a conducting state, while the switch SW is open. Accordingly, the storage capacitor Cₛ is charged with the data signal voltage DATA and no electric current flows through the transistor T1 to the light-emitting device 212. The voltage node X is equal to about the data signal voltage DATA and the voltage node Y is equal to about V_{ref}. A low voltage level of the scan signal SCAN turns both transistors T2, T3 to a non-conducting state while the switch SW is turned on, i.e. in a conducting state. Accordingly, an electric current flows through the transistor T1 to the light-emitting device 212, and the gate-drain voltage (V_{XY}) of the transistor T1 is equal to about (DATA−V_{ref}). With the transistor T1 operating in a saturation range, the electric current I delivered to the light-emitting device 212 can be expressed as follows:
I=k(DATA−V_{ref}−Vₜₕ)² (2),
wherein k is a constant coefficient, and Vₜₕ is the threshold voltage of the transistor T1. Since the reference voltage V_{ref} imposed at the node Y is constant, the electric current I delivered to the light-emitting device 212 can be maintained constant according to the level of the data signal voltage DATA.

FIG. 3B is a flowchart of a method of driving an electroluminescent display according to an embodiment of the invention. The electroluminescent display includes a plurality of light-emitting devices respectively coupled with scan and data lines SCAN, DATA. First, it is determined whether the scan signal SCAN associated with one light-emitting device is at a high voltage level, which can be logically expressed as “SCAN=1” (302). If SCAN=1, the data signal DATA coupled with the selected light-emitting device is stored (304). If SCAN=0, it is further determined whether a data signal DATA has been stored (306). If a data signal DATA is stored, an electric current is delivered to the light-emitting device according to the level of DATA while a constant voltage drop is applied to the light-emitting device (308). The light-emitting device can be thereby driven with a stable electric current.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

What is claimed is:

1. An electroluminescent display system, comprising:
a pixel driving circuit coupled with a scan line, a data line and one or more light-emitting device, wherein the pixel driving circuit when turned on in response to a scan signal issued on the scan line is configured to deliver to the light-emitting device an electric current set according to a data signal delivered through the data line; and
a voltage clamp circuit coupled between the pixel driving circuit and the light-emitting device, wherein the voltage clamp circuit is operable to apply a voltage potential at a connection node between the pixel driving circuit and the light-emitting device when an electric current is delivered to the light-emitting device.

2. The electroluminescent display according to claim 1, wherein the pixel driving circuit comprises:
a current driving circuit coupled with the light-emitting device, wherein the current driving circuit is operable to deliver an electric current to the light-emitting device according to the level of the data signal;
a storage capacitor coupled with the current driving circuit; and
a switch circuit operable to charge the storage capacitor with the data signal when receiving a turn-on scan signal.

3. The electroluminescent display according to claim 1, wherein the voltage potential applied by the voltage clamp circuit is constant.

4. The electroluminescent display according to claim 1, wherein the light-emitting device includes an organic light-emitting device.

5. The electroluminescent display according to claim 2, wherein the current driving circuit includes a first transistor having a drain connected to the light-emitting device, a source connected via a first switch to a power voltage, and a gate coupled with the storage capacitor.

6. The electroluminescent display according to claim 5, wherein the first transistor operates in a saturation range.

7. The electroluminescent display according to claim 2, wherein the switch circuit includes a second transistor operable to charge the capacitor with the data signal in response to receiving a turn-on scan signal.

8. The electroluminescent display according to claim 1, wherein the voltage clamp circuit includes a second switch operable to apply a fixed voltage potential at a connection node between the pixel driving circuit and the light-emitting device when an electric current is delivered to the light-emitting device.

9. The electroluminescent display according to claim 8, wherein the second switch of the voltage clamp circuit includes a third transistor coupled between a constant reference voltage and the connection node between the pixel driving circuit and the light-emitting device.

10. A method of driving an electroluminescent display, wherein the electroluminescent display includes a mesh of scan and data lines defining an array of pixels, each pixel including one or more light-emitting devices coupled with a pixel driving circuit, the method comprising:
selecting one pixel when the associated scan signal is at a first voltage level;
delivering a data signal to the selected pixel;
delivering an electric current to the light-emitting device of the selected pixel when the scan signal is at a second voltage level different from the first voltage level, wherein the level of the electric current is determined according to a level of the data signal; and
applying a voltage potential at a connection node between the pixel driving circuit and the light-emitting device while delivering the electric current to the light-emitting device.

11. The method according to claim 10, wherein applying a voltage signal at a connection node between the pixel driving circuit and the light-emitting device comprises applying a constant voltage potential at the connection node between the pixel driving circuit and the light-emitting device.

12. The method according to claim 10, wherein delivering an electric current to the light-emitting device of the selected pixel comprises operating a transistor in a saturation range.

13. A method of driving an electroluminescent display, wherein the electroluminescent display includes a plurality of pixels respectively comprised of one driving transistor and one light-emitting device connected to a drain of the driving transistor, the method comprising:
selecting one pixel by issuing a scan signal and a data signal addressed to the selected pixel;
operating the driving transistor in a saturated range to deliver an electric current to the light-emitting device of the selected pixel, wherein the electric current varies according to the level of the data signal; and
applying a voltage bias between the gate and the drain of the driving transistor while the driving transistor is operated in the saturated range.

14. The method according to claim 13, wherein applying a voltage bias between the gate and the drain of the driving transistor includes applying a constant voltage bias between the gate and the drain of the driving transistor being operated in the saturated range.

15. The method according to claim 14, wherein applying a constant voltage bias between the gate and the drain of the driving transistor further comprises:
applying the data signal to the gate of the driving transistor; and
applying a constant reference voltage to the drain of the driving transistor.

16. The method according to claim 13, wherein selecting one pixel is performed in a first time period, and operating the driving transistor in a saturated range is performed in a subsequent second time period.

17. The method according to claim 16, wherein the first time period corresponds to a first voltage level of the scan signal, and the second time period corresponds to a second voltage level of the scan signal different from the first voltage level.

18. The method according to claim 16, wherein the first time period further includes storing the data signal in a capacitor.
